(19) United States
(12) Patent Application Publication
(10) Pub. No.: US 2009/0016222 A1
(43) Pub. Date: Jan. 15, 2009

(54) METHODS AND SYSTEMS FOR IMPLEMENTING TIME-SLICE FLOW CONTROL

(75) Inventor: William B. Sebastian, Quincy, MA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 12/172,920

(22) Filed: Jul. 14, 2008

Related U.S. Application Data
(60) Provisional application No. 60/949,494, filed on Jul. 12, 2007.

(51) Int. Cl. G01R 31/08

(52) U.S. Cl. 370/236

(57) ABSTRACT

The present invention relates to systems, apparatus, and methods of controlling a transmission rate of packets over a network connection which are described in the disclosure. The method includes setting a target send rate. The target send rate indicates a number of packets that are to be transmitted in a time interval over a transmission medium. The method further includes transmitting a plurality of packets according to the target send rate.

### PRIORITY CLAIM

This application claims priority to U.S. Provisional Patent Application Ser. No. 60/949,494, filed Jul. 12, 2007, entitled “TIME-SLICE FLOW CONTROL,” Attorney Docket No. 026841-000300US, which is hereby incorporated be reference herein in its entirety for any purpose.

### FIELD OF THE INVENTION

The present invention relates, in general, to network acceleration and, more particularly, to bandwidth manipulations using time-slice flow control.

### BACKGROUND

Presently, in network systems sending at a rate greater than a link can support results in dropped packets, which can interfere with the performance of the network. Similarly, sending at a rate less than the link can handle can result in poor performance as well. Transmission Control Protocol (TCP) transport, presently the most widely used transport, primarily relies upon a “send window” to regulate packet flow. A sender emits packets until the amount of unacknowledged data reaches a limit controlled by the send window. Each acknowledgement advances the position of this window so that another packet can be sent. The size of this send window is adjusted as a means of avoiding congestion of links shared with other connections. The send window is gradually increased until it reaches a defined limit, and if dropped packets are detected, the send window is reduced as a means of avoiding network congestion.

Unfortunately, this approach can lead to poor performance for many networks. If the link drops packets due to problems in the physical layer, this triggers the congestion avoidance response, and the send rate is unnecessarily reduced. This approach also has problems with links with high bandwidth and high latency, such as broadband satellite links. In order to keep the network link fully utilized, the transport must be able to send a large number of packets onto the network before acknowledgements are received. Furthermore, intermediate network components such as routers or modems may have a limited ability to buffer data, so that the rapid sending of the packets may result in dropped packets and poor performance. Hence, improvements in the art are needed.

### BRIEF SUMMARY

Embodiments of the present invention are directed to a method of controlling a transmission rate of packets over a network connection, are described. The method includes setting a target send rate. The target send rate indicates a number of packets that are to be transmitted in a time interval over a transmission medium. The method further includes transmitting a plurality of packets according to the target send rate.

According to further embodiments, a system for controlling a transmission rate of packets over a network connection, is described. The system includes a first computing device configured as a sender. The first computing device has a control module which is configured to set a target send rate. The target send rate indicates a number of packets that are to be transmitted in a time interval. The system further includes a transmission medium coupled with the first computing device. The transmission medium is configured to transmit a plurality of packets according to the target send rate. The system also includes a second computing device coupled with the transmission medium. The second computing device is configured as a receiver and has a packet receive buffer configured to receive the plurality of packets.

In an alternative embodiment, a machine-readable medium is described. The machine-readable medium includes instructions for setting a target send rate. The target send rate indicates a number of packets that are to be transmitted in a time interval over a transmission medium. The machine-readable medium further includes instructions for transmitting a plurality of packets according to the target send rate.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram illustrating a system for implementing time-slice flow control, according to embodiments of the present invention.

FIG. 2 is a block diagram illustrating a system for further implementing time-slice flow control, according to one embodiment of the present invention.

FIG. 3 is a flow diagram illustrating a method of implementing time-slice flow control according to one embodiment of the present invention.

FIG. 4 is a generalized schematic diagram illustrating a computer system, in accordance with various embodiments of the invention.

FIG. 5 is a block diagram illustrating a networked system of computers, which can be used in accordance with various embodiments of the invention.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

Aspects of the invention relate to providing a mechanism for controlling the send rate of a network connection that is independent of packet loss and/or a send window. In one embodiment, a target send rate for a connection is determined, and packets are then transmitted across the connection at the target send rate. In a further embodiment, the packets are transmitted at the target send rate by buffering the packets through a network device and releasing them from the buffer according to the target send rate.

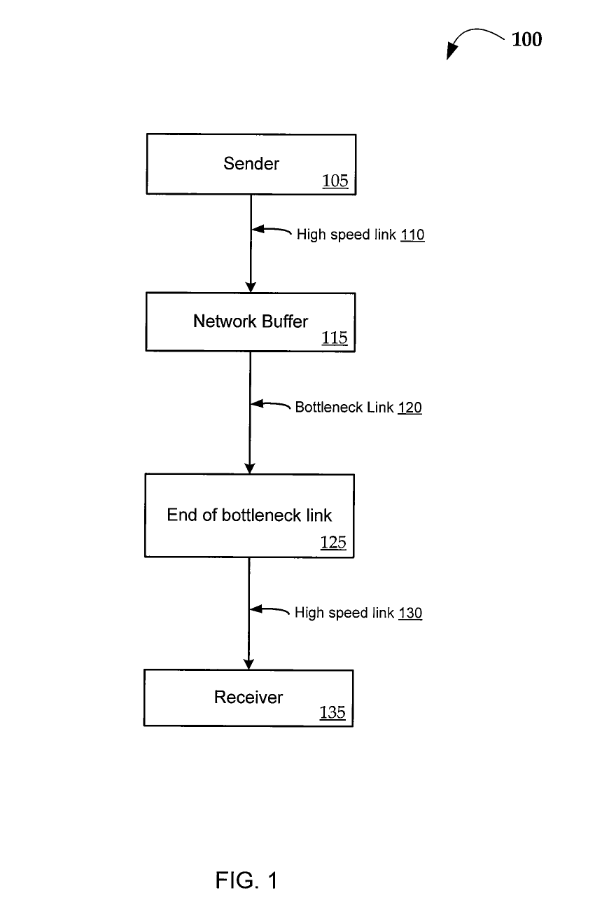

Turning now to FIG. 1 which illustrates a network 100 according to aspects of the invention. In one embodiment, network 100 includes a sender 105. Sender 105 may initiate the flow of packets into network 100. Sender 105 may also insert the flag (i.e., 1-bit flag) into the packet headers before transmitting them. Sender 105 may use network transport layer 4 to transmit the packets.

Network 100 may also include a receiver 135. Receiver 135 may be configured to receive the packets transmitted by sender 105. In addition, receiver 135 may also be configured to perform bandwidth measurements for network 100. In a further embodiment, network 100 may include a bottleneck link 120 which is a bandwidth-limited link that limits the bandwidth rate at which data may be transmitted between sender 105 and receiver 135. Bottleneck link 120 may occur at any time and be located at any point between sender 105 and receiver 135. In other words, bottleneck link 120 may be any link on network 100 where the bandwidth is limited.

One embodiment of the invention is to determine the maximum bandwidth of bottleneck link 120. The bandwidth of bottleneck link 120 may be the maximum rate in which packets may be transmitted between sender 105 and receiver 135. The bandwidth information can then be utilized by applications when transmitting packets associated with the application.

In a further embodiment, network 100 may further include a network buffer 115. Network buffer 115 may work in conjunction with bottleneck link 120 in order to accumulate a number of packets and emit them into bottleneck link 120 as quickly as the link can accept them. In one embodiment, network buffer 115 may be located in, for example, a modem, network router, network switch, link/physical layers 1 and 2, or any other network junction point. In a further embodiment, network buffer 115 may employ a variety of algorithms to determine which packets to discard when the buffer is filled at a faster rate then bottleneck link 120 can accept packets (i.e., the capacity of the buffer).

In one embodiment, network buffer 115 may be a finite size such that it may only be able to hold a finite payload of bytes and/or packets. In some embodiments, this finite size is referred to as network buffer size. As discussed above, if more packets than network buffer 115 can hold are received, buffer 115 will drop packets. Such dropping of packets can cause poor network performance. Thus, the time-slice flow control methods in accordance with embodiments of the invention may be employed to prevent the packets from being dropped. Accordingly, the flow control may be used to ensure that the number of packets that accumulate in buffer 115 is less than the amount at which packets begin to be dropped.

Network 100 may also include a location within the network referred to as the end of the bottleneck 125. The end of the bottleneck 125 may be a network device that receives packets after bottleneck 120. In one embodiment, the device at the end of bottleneck 125 does not require buffering; however, if the flow of the network traffic is reversed, then the device may include a buffer.

In a further embodiment, network 100 may include high speed link 110. In one embodiment, high speed link 110 is located between sender 105 and network buffer 115. Link 110 is a “high-speed” link because it is faster than bottleneck link 120. This link may be, for example, a local bus connected to a modem on the same computer system or it may be a link across the backbone of the Internet. Furthermore, network 100 may also include high speed link 130. High speed link 130 is similar to high speed link 110, except that it is located between the end of bottleneck 125 and receiver 135.

Further aspects of the invention involve the use of “time-slices” in which groups of packets are periodically sent in small bursts. The size of the bursts may be as large as possible to maximize context switching, but small enough not to exceed the buffering capabilities of network buffer 115.

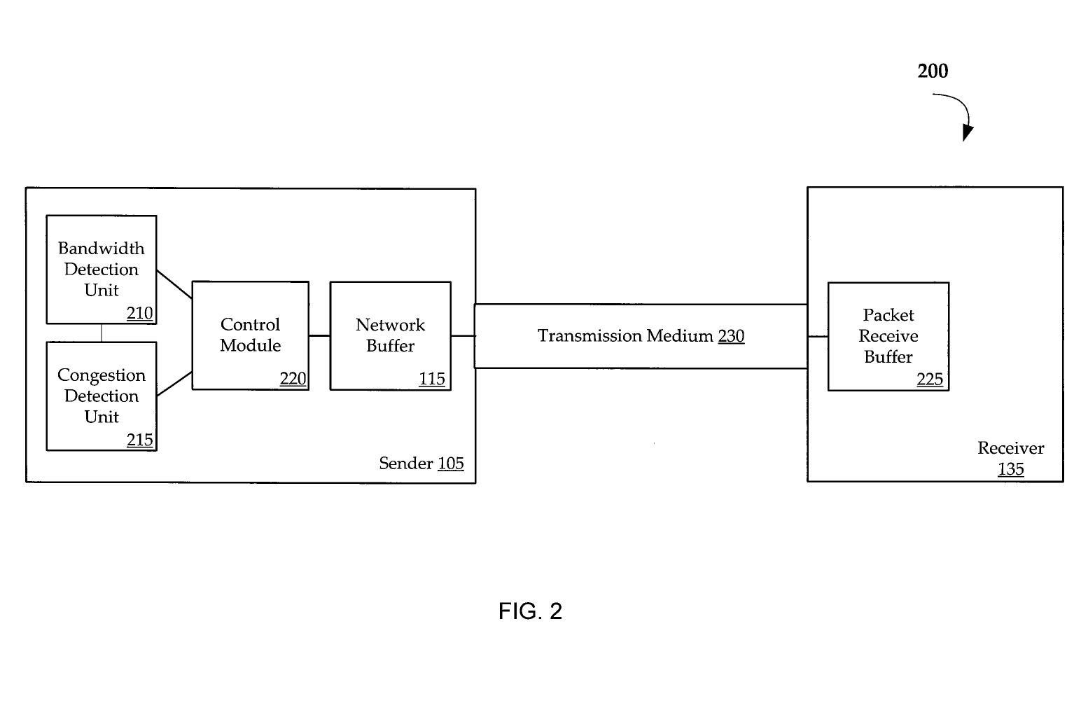

Turning now to FIG. 2, which illustrates a system 200 according to one embodiment of the invention. In one embodiment, system 200 includes sender 105, a transmission medium 230 and receiver 135. Sender 105 may include a bandwidth detection unit 210. Bandwidth detection unit 210 may be configured to detect the bandwidth capabilities of, for example, transmission medium 230. Furthermore, bandwidth detection unit 210 may implement the systems and methods for bandwidth measurement as described in the U.S. Patent Application, attorney docket number 026841-000410US, entitled METHODS AND SYSTEMS FOR BANDWIDTH MEASUREMENT TECHNIQUES, filed concurrently herewith, which is incorporated by reference in its entirety and for any purpose.

In a further embodiment, bandwidth detection unit 210 may be in communication with congestion detection unit 215. Bandwidth detection unit 210 may transmit the detected bandwidth of transmission medium 230 to congestion detection unit 215. Congestion detection unit 215 may utilize the bandwidth data received from bandwidth detection unit 210 when detecting the congestion of transmission medium 230 (e.g., a satellite connection, a local area connection (LAN), a wide area connection (WAN), a cellular connection, a wireless connection, a cable connection, a DSL connection, a dial-up connection, etc.). The congestion of transmission medium 230 may be calculated by congestion detection unit 215 using a variety of factors (e.g., the bandwidth data, the number of dropped packets, the pattern of the dropped packets, round trip times (RTT) of packets, physical characteristics of transmission medium 230, latency of transmission medium 230, etc.).

Bandwidth detection unit 210 and congestion detection unit 215 transmit the bandwidth and congestion data to control module 220. Control module 220 may be configured to, based on the bandwidth and congestion data, calculate a target send rate for transmission medium 230. The calculation of the target send rate may be a dynamic calculation. For example, as transmission medium 230 becomes more or less congested, congestion detection unit 215 may update control module 220 which may subsequently modify the target send rate. Furthermore, as the bandwidth capabilities of transmission medium 230 change, bandwidth detection unit 210 may update control module 220 accordingly. Consequently, the target send rate becomes a function of bandwidth and congestion.

In one embodiment, the target send rate is the rate at which the full capacity of transmission medium 230 may be used. For example, the target send rate may be, merely by way of example, 200,000 bytes per second, and a single packet may be 100 bytes. Therefore, in order to transmit at the target send rate, sender 105 would need to transmit 2000 packets per second. However, because of a variety of factors (e.g., the dynamic nature of the target send rate, context switching, send interrupt commands, etc.), it may be inefficient to simply determine the target send rate and transmit at that rate. For example, in order to indicate to sender 105 to transmit 200 packets a second, 2000 send commands must be issued every second to sender 105. Such commands may cause a slow down in packet transmission because of the continuous interruptions.

Instead, in one embodiment, control module 220 transmits the target send rate to network buffer 115. Control module 220 then transmits a burst of packets to packet network buffer 115 at a rate which, according to the target send rate, will maximize the transmission capabilities of transmission medium 230. In one embodiment, packet network buffer 115 releases the packets in accordance with the target send rate. Accordingly, the maximum transmission capacity of transmission medium 230 is dynamically maintained.

In one embodiment, receiver 135 receives the packets from transmission medium 230 through a packet receive buffer 225. When a packet is received, receiver 135 may transmit an acknowledgment (ack) message back to sender 105. The ack message may then be used to determine the RTT of transmission medium 230 and may also be used, in part, by bandwidth detection unit 210 and congestion detection unit 215 to determine the bandwidth and congestion of transmission medium 230.

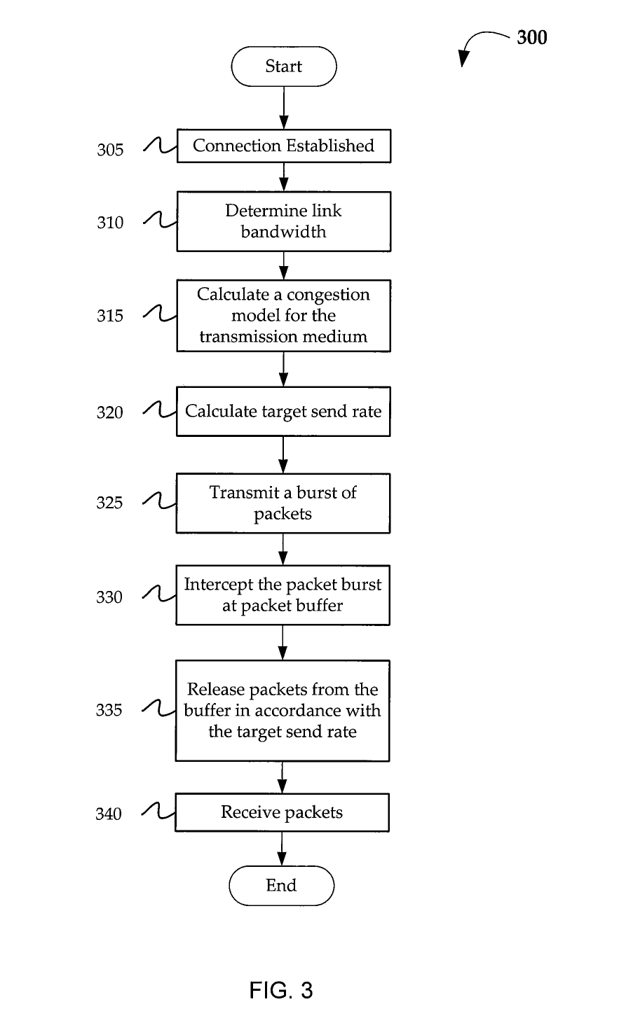

Turning now to FIG. 3, which illustrates a method 300 according to embodiments of the invention. At process block 305, a connection between a server (i.e., server 105 (FIG. 1)) and a client is established. In one embodiment, the server may be connected to multiple clients via the same transmission medium (i.e., transmission medium 130 (FIG. 1)). As such, the server may need to allocate bandwidth of the transmission medium for each of the multiple clients.

At process block 310, the bandwidth of the transmission medium is calculated. In one embodiment, the bandwidth is calculated by using packets already being transmitted over the transmission medium. In other words, the bandwidth may be calculated without introducing artificial test packets. In one embodiment, this type of bandwidth calculation may be achieved by incorporating a flag into each packet header. Accordingly, when the bandwidth is being calculated, the flags of the packets are set to true and, when the bandwidth is not being calculated, the flags are set to false.

At process block 315, a congestion model for the transmission medium is calculated. The congestion model may be based on multiple factors related to the transmission medium such as, bandwidth, the number of dropped packets, the pattern of the dropped packets, RTT, physical characteristics, latency, etc. For example, an increase in the number of dropped packets or a longer RTT may indicate congestion. However, any factor relied upon individually may not accurately reflect the congestion of the transmission medium. Hence, the factors in combination are used to calculate the congestion model.

In one embodiment, based on the bandwidth and congestion model, a target send rate is calculated (process block 320). In a further embodiment, the target send rate is the rate at which packets should be transmitted across a transmission medium in order to fully utilize the transmission medium's capacity, while at the same time provisioning for other connections that share the transmission medium. Furthermore, the target send rate may facilitate transmitting packets continuously (i.e., without unnecessary gaps in transmission or bunching of packets). In addition, the target send rate establishes a “time-slice” measurement for transmitting bursts of packets (process block 325). In one embodiment, the time-slice is a set amount of time that should elapse between transmissions of a burst of packets in order to maintain the target send rate.

At process block 330, the burst of packets is intercepted by, for example, network buffer 115 (FIG. 1). In one embodiment, network buffer 115 (FIG. 1) maintains a level of packets necessary both to continuously transmit packets and to transmit packets at the target send rate. At process block 335, packets within the buffer are released in accordance with the target send rate.

At process block 340, the client receives the packets. The client may then send an ack message back to the server indicating receipt of the packet. The server may then use the ack information as a factor in adjusting the target send rate.

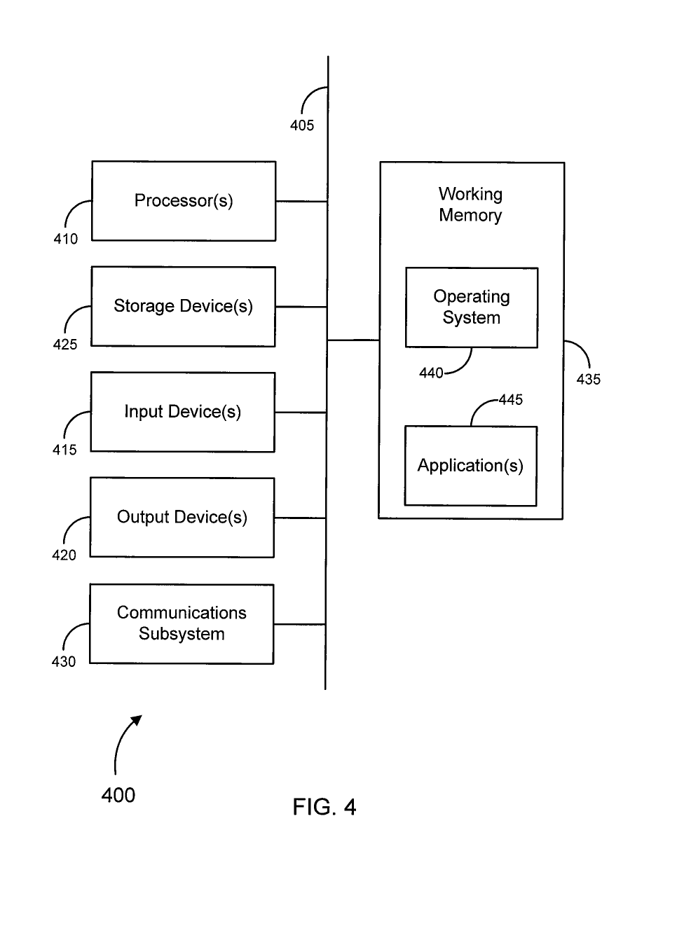

FIG. 4 provides a schematic illustration of one embodiment of a computer system 400 that can perform the methods of the invention, as described herein, and/or can function, for example, as any part of sender 105, receiver 135, etc. from FIG. 1. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements can include one or more processors 410, including without limitation one or more general-purpose processors and/or one or more special-purpose processors (such as digital signal processing chips, graphics acceleration chips, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more storage devices 425, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440 and/or other code, such as one or more application programs 445, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 400) to perform methods of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another machine-readable medium, such as one or more of the storage device(s) 425. Merely by way of example, execution of the sequences of instructions contained in the working memory 435 might cause the processor(s) 410 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 400, various machine-readable media might be involved in providing instructions/code to processor(s) 410 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 425. Volatile media includes, without limitation dynamic memory, such as the working memory 435. Transmission media includes coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc., carried by the signals) to the working memory 435, from which the processor(s) 405 retrieves and executes the instructions. The instructions received by the working memory 435 may optionally be stored on a storage device 425 either before or after execution by the processor(s) 410.

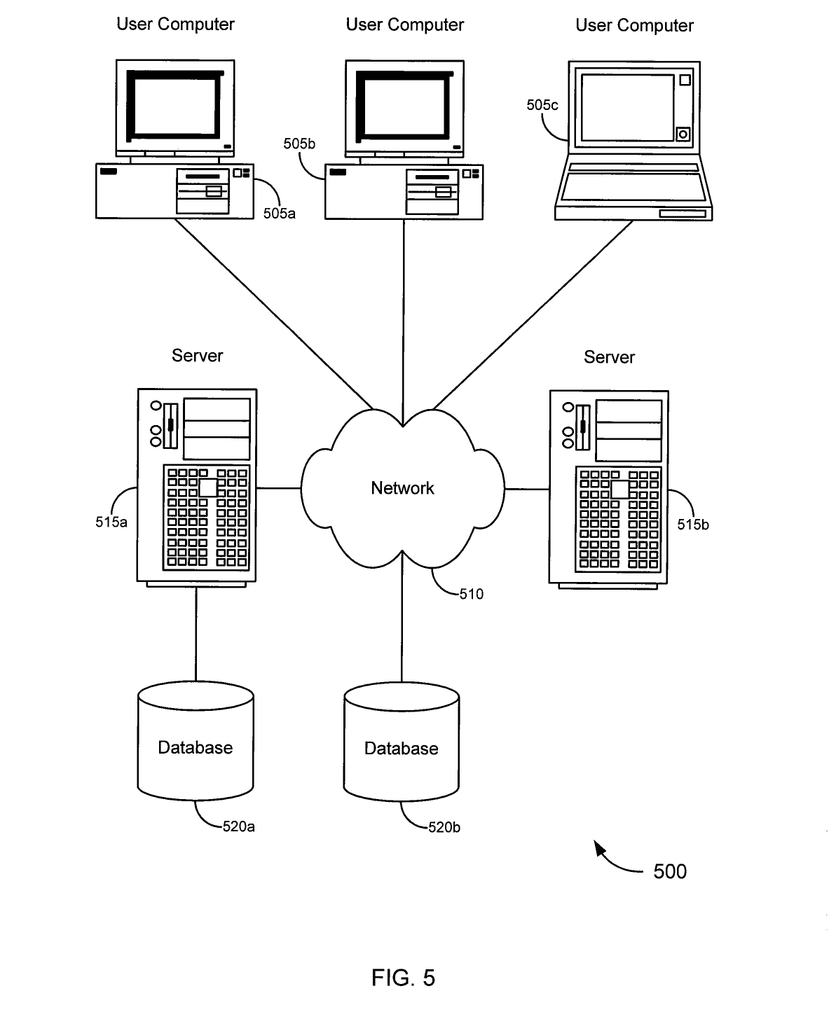

A set of embodiments comprises systems for implementing staged configurator modeling. In one embodiment, proxy server 320 and/or client 305 may be implemented as computer system 400 in FIG. 4. Merely by way of example, FIG. 5 illustrates a schematic diagram of a system 500 that can be used in accordance with one set of embodiments. The system 500 can include one or more user computers 505. The user computers 505 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 505 can also have any of a variety of applications, including one or more applications configured to perform methods of the invention, as well as one or more office applications, database client and/or server applications, and web browser applications. Alternatively, the user computers 505 can be any other electronic device, such as a thin-client computer, Internet-enabled mobile telephone, and/or personal digital assistant (PDA), capable of communicating via a network (e.g., the network 510 described below) and/or displaying and navigating web pages or other types of electronic documents. Although the exemplary system 500 is shown with three user computers 505, any number of user computers can be supported.

Certain embodiments of the invention operate in a networked environment, which can include a network 510. The network 510 can be any type of network familiar to those skilled in the art that can support data communications using any of a variety of commercially-available protocols, including without limitation TCP/IP, SNA, IPX, AppleTalk, and the like. Merely by way of example, the network 510 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 may be a web server, which can be used, merely by way of example, to process requests for web pages or other electronic documents from user computers 505. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 505 to perform methods of the invention.

The server computers 515, in some embodiments, might include one or more application servers, which can include one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configurator, database clients, API clients, web browsers, etc.) running on a user computer 505 and/or another server 515. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 505 via a web server (as described above, for example). Similarly, a web server might receive web page requests and/or input data from a user computer 505 and/or forward the web page requests and/or input data to an application server. In some cases a web server may be integrated with an application server.

In accordance with further embodiments, one or more servers 515 can function as a file server and/or can include one or more of the files (e.g., application code, data files, etc.) necessary to implement methods of the invention incorporated by an application running on a user computer 505 and/or another server 515. Alternatively, as those skilled in the art will appreciate, a file server can include all necessary files, allowing such an application to be invoked remotely by a user computer 505 and/or server 515. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as the database can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 520 can be a relational database, such as an Oracle™ database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of controlling a transmission rate of packets over a network connection, the method comprising:
setting a target send rate, wherein the target send rate indicates a number of packets that are to be transmitted in a time interval over a transmission medium; and
transmitting a plurality of packets according to the target send rate.

2. A method of controlling a transmission rate of packets over a network connection as recited in claim 1, further comprising intercepting the plurality of packets at a packet buffer.

3. A method of controlling a transmission rate of packets over a network connection as recited in claim 2, further comprising releasing the plurality of packets from the packet buffer in accordance with the target send rate.

4. A method of controlling a transmission rate of packets over a network connection as recited in claim 3, further comprising receiving the plurality of packets at a client system.

5. A method of controlling a transmission rate of packets over a network connection as recited in claim 1, wherein the target send rate is based on at least one of the network connection's bandwidth, and congestion model of the network connection.

6. A method of controlling a transmission rate of packets over a network connection as recited in claim 5, wherein the congestion model is determined based on at least one of a number of packet drops, a round trip time (RTT) of the network connection, packet drop patterns, and physical characteristics of the network connection.

7. A method of controlling a transmission rate of packets over a network connection as recited in claim 1, further comprising:
intercepting the transmission of the plurality of packets;
storing the plurality of packets in a packet transmission buffer; and
releasing the plurality of packets from the packet transmission buffer according to the target send rate.

8. A method of controlling a transmission rate of packets over a network connection as recited in claim 7, further comprising establishing a connection between a server and a client via the transmission medium.

9. A method of controlling a transmission rate of packets over a network connection as recited in claim 8, further comprising prior to setting the target send rate, determining a bandwidth of the transmission medium between the server and the client.

10. A method of controlling a transmission rate of packets over a network connection as recited in claim 9, further comprising calculating a congestion model of the transmission medium.

11. A method of controlling a transmission rate of packets over a network connection as recited in claim 10, wherein the congestion model of the transmission medium is calculated based on one or more of the following: the determined bandwidth of the transmission medium, a number of dropped packets, a pattern of the dropped packets, round trip times (RTT) of packets, physical characteristics of the transmission medium, and latency of the transmission medium.

12. A method of controlling a transmission rate of packets over a network connection as recited in claim 1, wherein the network connection is at least one of a satellite connection, a local area connection, a wide area connection, a cellular connection, a wireless connection, a cable connection, a DSL connection, and a dial-up connection.

13. A method of controlling a transmission rate of packets over a network connection as recited in claim 1, wherein the target send rate comprises a number of packets in which to send in a burst of packets.

14. A method of controlling a transmission rate of packets over a network connection as recited in claim 13, wherein the number of packets in the burst of packets is as large as possible to maximize context switching and small enough to not exceed buffering capabilities of the transmission medium.

15. A system for controlling a transmission rate of packets over a network connection, the system comprising:
a first computing device configured as a sender, the first computing device having a control module configured to set a target send rate, wherein the target send rate indicates a number of packets that are to be transmitted in a time interval;
a transmission medium coupled with the first computing device, the transmission medium configured to transmit a plurality of packets according to the target send rate; and
a second computing device coupled with the transmission medium, the second computing device is configured as a receiver and having a packet receive buffer configured to receive the plurality of packets.

16. A system for controlling a transmission rate of packets over a network connection as recited in claim 15, wherein the first computing device further having a bandwidth detection unit configured to determine a bandwidth of the transmission medium between the first computing device and the second computing device.

17. A system for controlling a transmission rate of packets over a network connection as recited in claim 16, wherein the first computing device further having a congestion detection unit configured to calculate a congestion model for the transmission medium.

18. A system for controlling a transmission rate of packets over a network connection as recited in claim 16, wherein the first computing device further having a packet buffer configured to buffer the transmission of the plurality of packets such that the plurality of packets are transmitted according to the target send rate.

19. A machine-readable medium having sets of instructions stored thereon which, when executed by one or more machines, cause the one or more machines to:
set a target send rate, wherein the target send rate indicates a number of packets that are to be transmitted in a time interval over a transmission medium; and
transmit a plurality of packets according to the target send rate.

20. A machine-readable medium as recited in claim 19, which, when further executed by the one or more machines, cause the one or more machines to:
intercept the plurality of packets at a packet buffer;
release the plurality of packets from the packet buffer in accordance with the target send rate; and
receive the plurality of packets at a client system.
